(19) United States
(12) Patent Application Publication
(10) Pub. No.: US 2022/0051090 A1
(43) Pub. Date: Feb. 17, 2022

(54) CLASSIFICATION METHOD USING A KNOWLEDGE GRAPH MODULE AND A MACHINE LEARNING MODULE

(71) Applicant: International Business Machines Corporation, Armonk, NY (US)

(72) Inventors: Andrea Giovannini, ZURICH (CH); Harold Douglas Dykeman, Richterswil (CH); Ivan Girardi, Birmensdorf (CH); Adam Ivankay, Zurich (CH); Chiara Marchiori, Birmensdorf (CH); Konrad Paluch, Adliswil (CH); Kevin Thandiackal, Gattikon (CH); Mario Zusag, Vienna (AT)

(21) Appl. No.: 16/989,953

(22) Filed: Aug. 11, 2020

(51) Int. Cl. G06N 3/08; G06N 3/04

(52) U.S. Cl. CPC G06N 3/08; G06N 3/0454

(57) ABSTRACT

An approach for determining a concatenated confidence value of a first class using an artificial-intelligence module (AI-module) for performing a classification based on the concatenated confidence value of the first class. The AI-module comprises a knowledge graph module, a machine learning module, and a weighting module. A processor determines a first confidence value of the first class as a first function of an input dataset using the machine learning module. A processor determines a second confidence value of the first class as a second function of the input dataset using the knowledge graph module. A processor determines the concatenated confidence value of the first class as a third function of the first confidence value of the first class, the second confidence value of the first class, and a value of a weighting parameter of the weighting module.

### BACKGROUND

The present invention relates to the field of machine learning systems, and more specifically, machine learning modules.

Machine learning systems are often used to classify input datasets. A classification may be performed by calculation of an output vector containing probabilities for several classes. A machine learning system can be trained by adjusting values of parameters of the machine learning system according to deviations of output datasets computed by the machine learning system and output datasets of training datasets. It is widely known that performance of a machine learning system highly depends on an architecture of the machine learning system and a training method used to train the machine learning system too, both highly dependent on the problem to be solved by the machine learning system.

### SUMMARY

Various embodiments provide a computer-implemented method, computer system, and computer program product for determining a concatenated confidence value of a first class using an artificial-intelligence module and for training an artificial intelligence module.

In one aspect, the computer implemented method determines a concatenated confidence value of a first class using an artificial-intelligence module (AI-module) for performing a classification based on the concatenated confidence value of the first class. The AI-module comprises a knowledge graph module, a machine learning module, and a weighting module. The knowledge graph module comprises a knowledge graph and a classification module. A processor determines a first confidence value of the first class as a function of an input dataset using the machine learning module. A processor determines a second confidence value of the first class as a function of the input dataset using the knowledge graph module. A processor determines the concatenated confidence value of the first class as a function of the first confidence value of the first class, the second confidence value of the first class, and a value of a weighting parameter of the weighting module, wherein the value of the weighting parameter weights the first confidence value of the first class and the second confidence value of the first class for determining the concatenated confidence value of the first class.

In another aspect, the computer implemented method trains an artificial-intelligence module. The AI-module comprises a knowledge graph module, a machine learning module, and a weighting module. The knowledge graph module comprises a knowledge graph and a classification module. A processor imports training datasets, the training datasets each comprising an input dataset and an output dataset, wherein each output dataset of the training datasets comprises a confidence value of a first class. A processor determines first training confidence values of the first class according to the training datasets as a function of the input dataset of the respective training dataset using the machine learning module. A processor determines second training confidence values according to the training datasets as a function of the input dataset of the respective training dataset using the knowledge graph module. A processor determines corresponding concatenated training confidence values of the first class according to the respective training datasets each as a function of the respective first training confidence value, the respective second training confidence value, and a value of a weighting parameter of the weighting module, wherein the value of the weighting parameter weights the respective first training confidence value and the respective second training confidence value for determining the corresponding concatenated training confidence value of the first class. A processor performs a comparison of each concatenated training confidence value of the first class with the confidence value of the first class of the output dataset of the respective training dataset. A processor changes a value of the parameter of the AI-module based on the comparisons.

### BRIEF DESCRIPTION OF THE DRAWINGS

FIG. 1 depicts a first computer system for determining a concatenated confidence value of a first class;

FIG. 2 depicts a block diagram for an exemplary AI-module;

FIG. 3 shows a flowchart of a computer implemented method for determining the concatenated confidence value of the first class using the exemplary AI-module shown in FIG. 2;

FIG. 4 shows a second computer system for training the exemplary AI-module shown in FIG. 2;

FIG. 5 depicts a block diagram for illustrating a training of the exemplary AI-module shown in FIG. 2; and

FIG. 6 shows a flowchart of a computer implemented method for training the exemplary AI-module shown in FIG. 2.

### DETAILED DESCRIPTION

The description of the various embodiments of the present invention are being presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The term “module” as used herein refers to any known or in the future developed hardware, software such as an executable program, artificial intelligence, fuzzy-logic or combination hereof for performing a function associated with the “module” or being a result of having performed the function associated with the “module”.

The machine learning module (ML-module) may be a module that can be used to perform a calculation of an output dataset of the ML-module based on the input dataset, in which the input dataset represents a request for using the ML-module. The ML-module may comprise a neuronal net, a convolutional neuronal net, and/or a radial basis function net. The input dataset and the output dataset of the ML-module may comprise values, preferably real values, as elements. The calculation may be performed dependent on values of parameters of the ML-module. In a preferred example, the values of the output dataset of the ML-module may represent each a probability to which of several classes the input dataset, or the case or the instance which corresponds to the input dataset, belongs to.

For example, the values of the output dataset of the ML-module may be each a confidence value for the respective class. The confidence value of the output dataset of the ML-module for each class may be a measure of how probable it is to group the input dataset, the corresponding case or instance, correctly into the respective class.

Regarding a first use case, the case or instance may be a medical patient, the values of the input dataset may correspond each to different symptoms of the patient and the respective classes may correspond to a respective different kind of treatment of the corresponding patient. The different symptoms may be different kinds of pains, e.g., pains in different parts of the body of the patient. In a first example, the input dataset may comprise integer values being equal either to zero or one. Each element of the input dataset may represent one of the symptoms in this case. The different kinds of treatment may be different points of care, e.g., a specialist, a hospital, medical advice via phone, or a general practitioner.

The ML-module may be in a trained state or an untrained state. For an application of the ML-module to the above described request for using the ML-module, the ML-module may be in the trained state. In the untrained state, the values of the parameters may be equal to random values. This may be achieved by initialization of the ML-module, wherein the values of the parameters may be set to random values. A training of the ML-module may be performed based on training datasets, each training dataset comprising an input dataset and an output dataset. The input and the output datasets of the training datasets may have elements. These elements may be values, preferably real values, similar to the elements of the input dataset and the output dataset of the ML-module. The training datasets may represent information about a classification problem, for which the ML-module may be used, once it is trained with the training datasets.

Regarding the first use case, the values of the output dataset of each training dataset may be each a confidence value for each class, which may be a measure how probable it is to group the input dataset of the respective training dataset, and by that the corresponding case or instance, correctly into the respective class. The values of each input dataset of the respective training datasets may correspond each to one of the symptoms of the corresponding patient. For example, the input dataset of the respective training datasets may comprise integer values being equal either to zero or one, wherein a value of one may refer to an occurrence of the respective symptom and a value of zero may refer to an absence of the respective symptom.

The training may be performed such that the values of the parameters may be adapted to reduce a training error of the ML-module. The training error may be calculated based on deviations of calculated values of training output datasets of the ML-module calculated by the ML-module and the values of each output dataset of the respective training datasets. Each training output dataset of the ML-module may be calculated based on the input dataset of the respective training dataset and may therefore be associated with the respective training dataset. The training output datasets of the ML-module may have the same structure as the output datasets of the training datasets, i.e., types of elements of the training output datasets of the ML-module may match types of elements of the output datasets of the training datasets.

Adapting the values of the parameters of the ML-module based on the deviations may reduce the training error. If the training error reaches a given threshold, the ML-module may be regarded as trained and may be in the trained state. Adapting the values of the parameters of the ML-module may be performed using one or more learning algorithms, such as linear regression, backpropagation, K-means, etc., and may be referred to as “machine learning”. The ML-module is either trained by machine learning, and by that in the trained state, or machine learning may be applied to the ML-module in order to change the state of the ML-module from the untrained state to an intermediate trained state or to the trained state, or from the intermediate trained state to the trained state. The ML-module may have different training states, e.g., the intermediate trained state, between the untrained and the trained state. In each different training state, the ML-module may comprise a different combination of values of the parameters of the ML-module.

The machine learning may provoke that values of the training datasets may not be accessible in the trained state or intermediate trained state of the ML-module by reading out the values of the ML-module, e.g., by reading out the values of the parameters of the ML-module. The values of the parameters of the ML-module may be referred to as data of the ML-module. The data of the ML-module may comprise values of weights of the neuronal net.

The knowledge graph module (KG-module) may comprise a data structure containing the values of all or a part of the training datasets. In a first example, the data structure of the KG-module may comprise the values of the input datasets of the training datasets. In a second example, the data structure of the KG-module may comprise the values of all input datasets of the training datasets. In a third example, the data structure of the KG-module may comprise the values of the input datasets of the training datasets and of the output datasets of training datasets.

The more values of the training datasets the data structure of the KG-module comprises, the more flexible this data structure may be used. The data structure of the KG-module may be stored in a volatile memory element and/or a persistent storage device such that the values of the training datasets may be accessible in a trained state or an intermediate trained state of the KG-module by reading out the values of the KG-module, e.g., by reading out the values of the data structure of the KG-module. This may be a feature that distinguishes the ML-module from the KG-module.

The values of the data structure of the KG-module may be visualizable by a knowledge graph. The knowledge graph may comprise a set of nodes. Each node of the knowledge graph may represent a single value of an input or an output dataset of one of the training datasets. The set of nodes may comprise various subsets of nodes. Each subset of nodes may represent one of the training datasets. For example, all nodes of each subset of nodes may represent all values of that training dataset. Therefore, to each subset of nodes, a corresponding training dataset may be assigned. The term “represents” may be interpreted in one example such that all the nodes of the set of nodes may be visualizable in one plane with each node being labelled by the single value the respective node represents. By such kind of representation, the values of each training dataset may be visualizable.

Each node of each respective subset of nodes may represent either a single value of an input dataset or a single value of an output dataset of the corresponding training dataset. All nodes of each subset of nodes may represent all values of the respective training dataset. As each node represents a single value of one of the training datasets, the nodes may be regarded as being stored by storing the respective values of the training datasets, which may be associated to the respective nodes.

The values of the input datasets and the output datasets of the training datasets may be comprised in data structure of the KG-module in the form of first vectors and/or first pointers.

Furthermore, the knowledge graph may comprise a set of edges. Preferably, the nodes of each subset of nodes may be connected each via a subset of edges of the set of edges. Therefore, the nodes of each subset of nodes may be associated to the subset of edges which connects the nodes of that subset of nodes. A first connection of a first node of each subset of nodes to a second node of the same subset of nodes may be represented by a first edge of the respective subset of edges the first and the second node may be associated to.

The first connection or first edge of the respective subset of edges may represent a relationship between the first node and the second node, e.g., a probability that the first node belongs to the second node. In other words, the first connection or first edge of the respective subset of edges may represent a probability that the value of the training dataset the first node represents may occur in the same case or instance as the value of the training dataset the second node represents. Similarly, in the knowledge graph, further nodes of each subset of nodes may be connected by further edges of the respective subset of edges corresponding to the respective subset of nodes. The further edges may represent relationships between the further nodes.

Based on the above described first use case, the first edge may represent a probability that the first symptom and the second symptom occurs in the same case or instance, i.e., in the same patient.

The data structure of the KG-module may comprise further values indicating relationships between values of the training datasets. Preferably, the further values of the data structure of the KG-module may each correspond to a strength of a relationship between two values of the training datasets, preferably between two values of a single training dataset of the training datasets.

The probabilities, which the edges of the set of edges may represent, may be stored in the volatile memory element and/or the persistent storage device in the form of second vectors, matrices and/or second pointers. For example, for each patient, a matrix may be stored. So, for several patients, several corresponding matrices may be stored. Each row and column of the corresponding matrices may represent one of the symptoms. Elements of each of the matrices may represent probabilities for one of the symptoms and another symptom occurring in the same patient. In this case, the diagonals of the matrices may have elements equal to one or 100. The values of the data structure of the KG-module may comprise the probabilities the edges of the set of edges may represent.

The probabilities for each symptom of each patient may be given by a real number in the input dataset of the respective training dataset in a first example or in a supplementary data structure of the data structure of the KG-module in a second example. Considering the first example, if no intercorrelation between the symptoms may be considered, the input datasets of the training datasets may have a vector structure. If an intercorrelation between the symptoms may be considered, the input datasets of the training datasets may comprise the structure of the above described matrices. The edges of the set of edges may be visualizable by arranging the edges between the nodes in the plane mentioned above. Hence, the relationships between the node, preferably the probabilities, may be visualizable by the knowledge graph. Considering the second example, the supplementary data structure may comprise the above described matrices.

The AI-module may comprise a visualization module. The visualization module may calculate visualization data based on the data structure of the KG-module such that knowledge graph comprising the labelled nodes and the labelled edges may be visualized by means of a display using the visualization data.

The KG-module may comprise a query module. The query module may perform a query using the data structure of the KG-module. For example, the query module may perform a first query searching for all subset of nodes comprising the first symptom and the second symptom. In a first example, considering the first use case, the values of the training datasets may be stored in the form of corresponding vectors in the storage device, preferably comprising either a “1” or “0” as vector values. A value of “1” in element number “n” of each vector may indicate an occurrence of the n-th symptom in the instance the vector and by that the corresponding training dataset represents. In this first example, the first query may be performed by searching for all vectors whose first and second elements are equal to the value “1”.

The query module may also perform the query using the probabilities of the symptoms which are represented by the edges of the knowledge graph and may be stored in the form of the matrices, preferably in the supplementary data structure. For example, the query module may perform a second query searching for all matrices indicating a probability of ninety percent or higher that a third symptom and a fourth symptom occur in the same instance, i.e. the same patient.

The query module may perform several different queries using the values of the data structure of the KG-module and preferably the probabilities. For each query, the query module may calculate a corresponding query result. The query results may each have a vector or a matrix structure. The different queries may be performed using graph operations.

Preferably, the query or the queries may calculate the query results dependent on the input dataset. For example, the query or the queries may comprise a comparison of the values of the input dataset with values of the data structure of the KG-module.

The KG-module may comprise a classification module for determining an output dataset of the KG-module based on the input dataset and the query results. The output dataset of the KG-module may have the same structure as the output dataset of the ML-module. Preferably, values of the output dataset of the KG-module may represent each a probability to which of the several classes the input dataset, or the case or the instance which corresponds to the input dataset, belongs to.

For example, considering the first use case, the values of the output dataset of the KG-module may be each a confidence value for the respective class. The confidence value of the output dataset of the KG-module for each class may be a measure of how probable it is to group the input dataset, and by that the corresponding case or instance, correctly into the respective class.

The classification module may calculate the output dataset of the KG-module based on decision rules and on the query results. The decision rules may comprise parameters referred to as parameters of KG-module.

The training of the KG-module may be performed such that the values of the parameters of the KG-module may be adapted to reduce a training error of the KG-module. The training error of the KG-module may be calculated based on deviations of calculated values of training output datasets of the KG-module calculated by the KG-module and the values of each output dataset of the respective training datasets. Each training output dataset of the KG-module may be calculated based on the input dataset of the respective training dataset. Hence, the respective training dataset as well as the input dataset of the respective training dataset are used for a calculation of each training output dataset of the KG-module and may be associated to this respective training output dataset of the KG-module.

The training output datasets of the KG-module may have the same structure as the output datasets of the training datasets, i.e., types of elements of the training output datasets of the KG-module may match types of elements of the output datasets of the training datasets.

A calculation of each training output dataset of the KG-module based on the corresponding input dataset may be performed in the same manner as the determination of the output dataset of the KG-module based on the input dataset described above, i.e., by using the query module and the classification module.

Adapting the values of the parameters of the KG-module based on the deviations may reduce the training error of the KG-module. If the training error of the KG-module reaches a given threshold, the KG-module may be regarded as trained and may be in the trained state. Adapting the values of the parameters of the KG-module may be performed using one or more learning algorithms such as linear regression, backpropagation, K-means, etc. The KG-module may have different training states, e.g., an intermediate trained state, between an untrained and the trained state. In each different training states, the KG-module may comprise a different combination of values of the parameters of the KG-module.

The advantage of using the KG-module may be that the calculation of the output dataset of the KG-module may be followed up to each single value of the training datasets being used for this calculation. Therefore, the KG-module may be regarded as a white box model for this calculation. On the contrary, the calculation of the output dataset of the ML-module may not be followed up to each single value of the training datasets being used for this calculation. Therefore, the ML-module may be regarded as a black box model for this calculation. The ML-module may have the advantage of having better generalization properties and lower requirements of calculation cost and memory.

The visualization module may facilitate the use of the white box characteristic of the KG-module. Though the visualization module may not be necessarily needed to determine the concatenated confidence value of the first class and perform the classification, it may be used to analyze a case, in which the first confidence value may differ from the second confidence value. To realize this, the visualization module may highlight nodes and edges of the knowledge graph, which may be used to calculate the concatenated confidence value of the first class.

Furthermore, the values of the data structure of the KG-module may be extended in an easier way compared to extending the data of the ML-module. For example, considering the KG-module, for each new training dataset, a new vector or matrix may be added to the data structure of the KG-module. Considering the ML-module, in many cases, a training of the ML-module as described above may be necessary to include information of the new training dataset. A retraining of the ML-module may be more time-consuming than adding the new vector or matrix to the data structure of the KG-module. In addition to that, complex queries and information retrieval problems may be solved efficiently using the KG-module, preferably by using task-specific graph operations.

A very special advantage of the KG-module may be that new information, aside from the information of new training datasets, may be inserted in the data structure of the KG-module and then may be used for calculating the output dataset of the KG-module. For example, based on new research studies, the supplementary data structure may be changed, for example, by changing the probabilities for the intercorrelations between the symptoms.

As described above, the output dataset of the ML-module may be calculated in a different way compared to the output dataset of the KG-module. Furthermore, the ML-module may be trained in a different way compared to the KG-module. For these reasons, the ML-module may perform better, e.g., calculate more accurate confidence values for the respective classes, in certain subspaces of an admissible input space of the input dataset than the KG-module and vice versa. Therefore, combining the output dataset of the ML-module with the output dataset of the KG-module may lead to better classification results compared to using just one of the two modules, the ML-module or the KG-module.

In the following, the first use case may be simplified by considering only one of the several classes, referred to as the first class. In this case, the value of the output dataset of the ML-module may be referred to as the first confidence value of the first class and the value of the output dataset of the KG-module may be referred to as the second confidence value of the first class.

Using the ML-module and the KG-module for determining the concatenated confidence value of the first class may be advantageous because the advantage of the KG-module may be combined with the advantages of the ML-module. This may result in the concatenated confidence value of the first class being more accurate than the first confidence value of the first class and the second confidence value of the first class as described above.

The above-mentioned training method may have the advantage of changing the KG-module, the ML-module, and/or the weighting module from an untrained state to a trained state, and by that the AI-module from an untrained state to a trained state. In doing so, the above described advantages of using the KG-module and the ML-module for calculating the concatenated confidence value may be realized by using the AI-module being in the trained state.

According to one embodiment, the method comprises: determining a first confidence value of a second class as a function of the input dataset using the machine learning module; determining a second confidence value of the second class as a function of the input dataset using the knowledge graph module; determining a concatenated confidence value of the second class as a function of the first confidence value of the second class, the second confidence value of the second class, and the value of the weighting parameter or a value of a further weighting parameter of the weighting module, wherein the value of the weighting parameter or the value of the further weighting parameter weights the first confidence value of the second class and the second confidence value of the second class for determining the concatenated confidence value of the second class; and performing the classification based on the concatenated confidence value of the first class and the concatenated confidence value of the second class.

Using the second class in addition to the first class may enable a more complex decision making using the method. With only the first class, an emergency may be detected. This may already be useful even if the value of the weighting parameter is a fixed value. The weighting may be fixed, e.g., 0.5, wherein the concatenated confidence value of the first class may be calculated by summing up half of the value of the first confidence value and half of the value of the second confidence value. The AI-model may classify an emergency when the concatenated confidence value is above 50%. Similarly, using the first and the second class may achieve good results even if the value of the weighting parameter is fixed.

According to one embodiment, the method further comprises performing the weighting of the first confidence value of the first class and the second confidence value of the first class as a function of the input dataset, wherein the value of the weighting parameter is dependent on the input dataset. As mentioned above, the ML-module may perform better, i.e., calculate more accurate confidence values for the respective classes, in the certain subspaces of an admissible input space of the input dataset than the KG-module and vice versa. The value of the weighting parameter may change in such a way that if the values of the input dataset are located in the certain subspaces where a performance of the ML-module is higher than a performance of the KG-module, the first confidence value may be weighted higher than the second confidence value and vice versa.

According to one embodiment, the value of the weighting parameter is dependent on the first confidence value of the first class and the second confidence value of the first class. One example of this embodiment may be that the first confidence value may be weighted with zero if the first confidence value is below a given first threshold. Similarly, the second confidence value may be weighted according to this embodiment. This embodiment may reduce the risk of calculating the concatenated confidence value inaccurately.

According to one embodiment, the method further comprises: determining a bias value as a function of the input dataset; and performing the weighting of the first confidence value of the first class and the second confidence value of the first class as a function of the bias value using the weighting module. This embodiment may be a special example of the value of the weighting parameter being dependent on the input dataset. In a simple embodiment, the weighting module may only consist of the weighting parameter. In a more sophisticated example, the weighting module may calculate the concatenated confidence value of the first class based on the first confidence value, the second confidence value, and the input dataset. Using the bias value may reduce a complexity of this sophisticated example as an influence of the input dataset on the weighting may be reduced to only one scalar. This may also alleviate the training of the AI-module.

According to one embodiment, the method further comprises: determining a third confidence value of the first class as a function of the input dataset using a further knowledge graph module or a further machine learning module; and determining the concatenated confidence value of the first class as a function of the first confidence value of the first class, the second confidence value of the first class, and the third confidence value of the first class. The further knowledge graph module and the further machine learning module may comprise the same components and the same functionality as the above described KG-module and the above described ML-module, respectively. The further knowledge graph module or the further machine learning module may have a better performance in second certain subspaces of the admissible input space than the KG-module or the ML-module, respectively. For that reason, the overall performance of the AI-module may be enhanced using the further knowledge graph module or the further machine learning module.

According to one embodiment, the method further comprises determining the concatenated confidence value of the first class based on a decision rule, wherein the decision rule comprises the weighting parameter. This embodiment may contribute to a more white box character of the weighting module. The weighting module may comprise several decision rules. The visualization module may highlight which one of the decision rules may be used to calculate the concatenated confidence value of the first class.

According to one embodiment, the method further comprises determining the concatenated confidence value of the first class using a second machine learning module, wherein the weighting module comprises the second machine learning module and the second machine learning module comprises the weighting parameter. According to this embodiment, the weighting parameter may be of a similar type like further parameters of the second machine learning module. This embodiment may have the advantage that no expert may be needed to build, use, or supervise the weighting module. For example, the weighting module may calculate the concatenated confidence value without using a decision rule.

According to one embodiment, the second machine learning module comprises a neuronal network with a hidden layer. In this embodiment, the weighting parameter may be one of several weights of the neuronal network. Generally, neuronal networks may have good generalization properties. The neuronal network may comprise sigmoid functions to realize these generalization properties.

According to one embodiment, the method further comprises: determining a first scoring value and a second scoring value, wherein the first scoring value represents a value of an uncertainty of the first confidence value of the first class and the second the scoring value representing a value of an uncertainty of the second confidence value of the first class; and determining the concatenated confidence value of the first class as a function of the first scoring value and the second scoring value. This may enable a user of the AI-module to understand a “reasoning” of the weighting module easier. Thus, the weighting module may be closer to a white box model. The visualization data may comprise data to display the first scoring and the second scoring value on the display.

According to one embodiment, the method further comprises: calculating an output dataset of the weighting module using the weighting module, wherein the output dataset of the weighting module comprises concatenated confidence values of several classes including the concatenated confidence value of the first class and the concatenated confidence value of the second class, and wherein the sum of the concatenated confidence values is equal to 1 or 100 such that each concatenated confidence value represents a probability of the respective class; and performing the classification based on the output. The latter feature may facilitate using the output dataset of the weighting module for performing the classification. For example, to classify the input dataset, the input dataset may be grouped into the class comprising the highest concatenated confidence value. The latter may be found by choosing the highest value of the output dataset of the weighting module.

According to one embodiment, the training method further comprises adapting values of parameters of the knowledge graph module, values of parameters of the machine learning module, and the value of the weighting parameter. This may provoke a faster training, preferably if a complex classification task may be solved using the AI-module. This embodiment of the training method is referred to as the first training method.

According to one embodiment, the training method further comprises performing a backpropagation algorithm, the backpropagation algorithm comprising adapting the values of the parameters of the knowledge graph module, the values of the parameters of the machine learning module and the value of the weighting parameter each based on a respective value of a derivative of an error value according to the corresponding parameter, wherein the error value is calculated using each concatenated training confidence value of the first class and the confidence value of the first class of the output dataset of the respective training dataset, wherein first functions including the parameters of the machine learning module, second functions including the parameters of the knowledge graph module, and third functions including the parameters of the weighting module are differentiable. Using the backpropagation algorithm may provoke a fast training of the AI-module and may enable better generalization properties of the AI-module. This embodiment of the training method is referred to as the second training method.

According to one embodiment, the training method further comprises performing a backpropagation algorithm, the backpropagation algorithm comprising adapting the values of the parameters of the machine learning module and the value of the weighting parameter each based on a respective value of a derivative of an error value according to the corresponding parameter, wherein the error value is calculated using each concatenated training confidence value of the first class and the confidence value of the first class of the output dataset of the respective training dataset, wherein first functions including the parameters of the machine learning module and third functions including the parameters of the weighting module are differentiable. This embodiment may allow to leave the values of the parameters of the KG-module unchanged while performing the backpropagation algorithm. This may have the advantage of preserving the white box characteristic of the KG-module as much as possible. This embodiment of the training method is referred to as the third training method.

According to one embodiment, the training method further comprises performing a training of the weighting module using the first training confidence values of the first class, the second training confidence values of the first class, the concatenated training confidence values, and the output datasets of the training datasets, wherein performing the training of the weighting module comprises adapting the value of the weighting parameter. This may allow to leave the values of the parameters of the ML-module and the KG-module unchanged while performing the training of the AI-module. This may be useful in cases the ML-module and the KG-module being in the trained state and each trained state has been reached using high performance computing with high performance computing resources being unavailable for training the weighting module. This embodiment of the training method is referred to as the fourth training method.

According to one embodiment, the training method further comprises performing a training of the weighting module using the first training confidence values of the first class, the second training confidence values of the first class, the concatenated training confidence values, and the output datasets of the training datasets, wherein the weighting module comprises a decision rule module, and wherein performing the training of the weighting module comprises adapting the value of the weighting parameter without changing a value of a parameter of the decision rule. Leaving the value of the parameter of the decision rule unchanged may have the advantage that a part of the weighting module comprising the decision rule may keep its white box character. This embodiment of the training method is referred to as the fifth training method.

According to one embodiment, the training method further comprises determining a corresponding bias value as a function of the input dataset of the respective training dataset and performing the weighting of the respective first training confidence value of the first class and the respective second training confidence value of the first class as a function of the respective bias value using the weighting module and adapting a value of a parameter for determining the bias value as a function of a prior distribution of the training datasets. The bias value may be calculated based on the input dataset of the respective training dataset by using a bias function. The bias function may comprise the parameter for determining the bias value dependent on the input dataset of the respective training dataset. If the value of that parameter may be adapted as a function of the prior distribution, known differences in the performances of the ML-module and the KG-module may be incorporated in the training method.

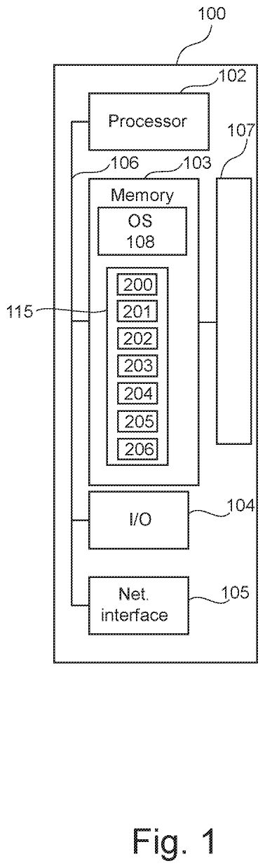

FIG. 1 shows a first computer system 100 for determining a concatenated confidence value of a first class using an exemplary AI-module 1 for performing a classification based on the concatenated confidence value of the first class. The first computer system 100 may be suited for performing method steps as involved in the disclosure. The first computer system 100 may include a first processor 102, a first memory 103, a first I/O circuitry 104, and a first network interface 105 coupled together by a first bus 106.

The first processor 102 may represent one or more processors (e.g. microprocessors). The first memory 103 may include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM). Note that the first memory 103 may have a distributed architecture, where various components are situated remote from one another, but may be accessed by the first processor 102.

The first memory 103 in combination with a first persistent storage device 107 may be used for local data and instruction storage. The first storage device 107 includes one or more persistent storage devices and media controlled by the first I/O circuitry 104. The first storage device 107 may include magnetic, optical, magneto optical, or solid-state apparatus for digital data storage, for example, having fixed or removable media. Sample devices include hard disk drives, optical disk drives and floppy disks drives. Sample media include hard disk platters, CD-ROMs, DVD-ROMs, BD-ROMs, floppy disks, and the like.

The first memory 103 may include one or more separate programs, each of which comprises an ordered listing of executable instructions for implementing logical functions, notably functions involved in examples. The software in the first memory 103 may also typically include a first suitable operating system (OS) 108. The first OS 108 essentially controls the execution of other computer programs for implementing at least part of methods as described herein.

The first computer system 100 may be configured for functions such as executing the above-mentioned functions associated with the ML-module on the first computer system 100, referred to as first functions. The first functions may comprise calculating of the output dataset of the ML-module based on the input dataset, training the ML-module based on the training datasets as mentioned above, loading the ML-module being in the trained state into the first memory 103.

Furthermore, the first computer system 100 may be configured for functions such as executing the above-mentioned functions associated with the KG-module on the first computer system 100, referred to as second functions. The second functions may comprise calculating of the output dataset of the KG-module based on the input dataset, training the KG-module based on the training datasets as mentioned above, loading the KG-module being in the trained state into the first memory 103.

Furthermore, the first computer system 100 may be configured for functions such as executing the above-mentioned functions associated with the weighting module on the first computer system 100, referred to as third functions. The third functions may comprise calculating of the output dataset of the exemplary AI-module 1 based on the output dataset of the KG-module, the output dataset of the ML-module, and the value of the weighting parameter.

Furthermore, the first computer system 100 may be configured for functions such as determining a first confidence value of the first class as a function of an input dataset using the machine learning module, referred to as a fourth function, determining a second confidence value of the first class as a function of the input dataset using the knowledge graph module, referred to as a fifth function, determining the concatenated confidence value of the first class as a function of the first confidence value of the first class, the second confidence value of the first class, and a value of a weighting parameter of the weighting module, wherein the value of the weighting parameter weights the first confidence value of the first class and the second confidence value of the first class for determining the concatenated confidence value of the first class, referred to as sixth function.

The first computer system 100 may perform the first functions, second functions, third functions, fourth function, fifth function, and sixth function by executing a first program 201, a second program 202, a third program 203, a fourth program 204, a fifth program 205, and a sixth program 206, respectively. The exemplary AI-module 1 may be run by executing a first main program 200 on the first processor 102. The first main program 200 may initiate an execution of the first program 201, the second program 202, the third program 203, the fourth program 204, the fifth program 205, and the sixth program 206 on the first processor 102.

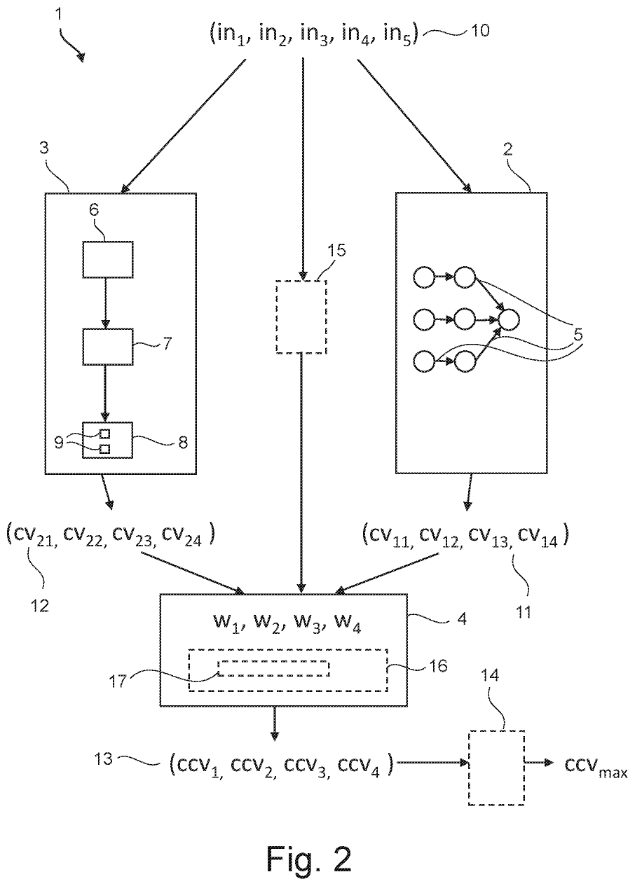

FIG. 2 depicts a block diagram for the exemplary AI-module 1 for performing the classification based on at least the concatenated confidence value of the first class. The exemplary AI-module may comprise an exemplary ML-module 2, an exemplary KG-module 3, and an exemplary weighting module 4. The exemplary ML-module 2 may comprise parameters 5. The exemplary KG-module 3 may comprise an exemplary data structure 6, an exemplary query module 7, and an exemplary classification module 8 with parameters 9. The exemplary AI-module 1, the exemplary ML-module 2, the exemplary KG-module 3, the exemplary data structure 6, the exemplary query module 7, and the exemplary classification module 8 may be designed like the above described AI-module, ML-module, KG-module, data structure, query module, and classification module, respectively. Therefore the exemplary AI-module 1, the exemplary ML-module 2, the exemplary KG-module 3, the exemplary data structure 6, the exemplary query module 7, and the exemplary classification module 8 may comprise the same components and may have the same functionalities like the above described AI-module, ML-module, KG-module, data structure, query module, and classification module, respectively.

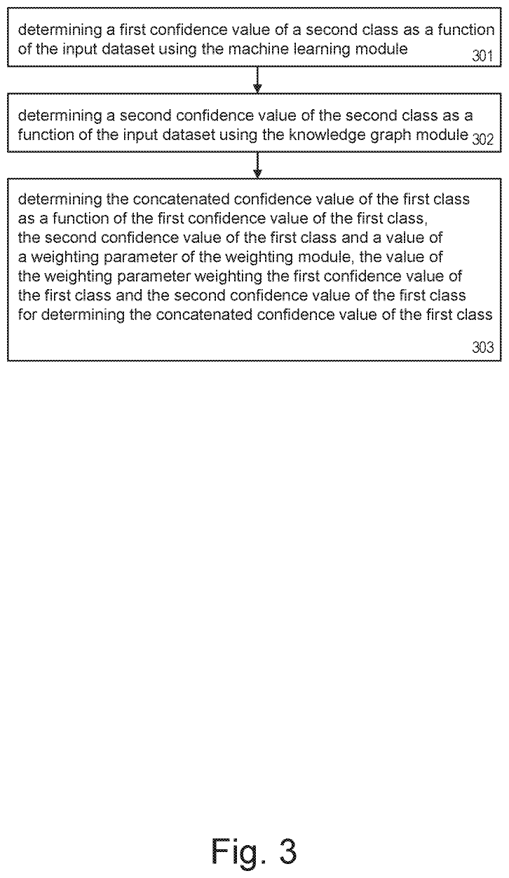

FIG. 3 shows a flowchart of a computer implemented method for determining the concatenated confidence value of the first class using the exemplary AI-module 1 for performing the classification. In step 301, the exemplary ML-module 2 may determine a first confidence value cv₁₁ of a first class, a first confidence value cv₁₂ of a second class, a first confidence value cv₁₃ of a third class, and a first confidence value cv₁₄ of a fourth class each as a function of an input dataset 10. The input dataset 10 may comprise values in₁, in₂, in₃, in₄, and ins. Considering the first use case, the values in₁, in₂, in₃, in₄, and ins of the input dataset 10 may each correspond to one of the different symptoms of the patient mentioned above. The values cv₁₁, cv₁₂, cv₁₃, and cv₁₄ may be exported by the exemplary ML-module 2 in the form of an output dataset of the exemplary ML-module 11.

In step 302, the exemplary KG-module 3 may determine a second confidence value cv₂₁ of the first class, a second confidence value cv₂₂ of the second class, a second confidence value cv₂₃ of the third class, and a second confidence value cv₂₄ of the fourth class, preferably using the exemplary data structure 6, the exemplary query module 7, and the exemplary classification module 8. The first class may refer to a treatment of the patient at a specialist, the second class to a treatment of the patient in a hospital, the third class to a treatment of the patient via medical advice via phone, and the fourth class to a treatment of the patient at a general practitioner. The values cv₂₁, cv₂₂, cv₂₃, and cv₂₄ may be exported by the exemplary KG-module 3 in the form of an output dataset of the exemplary KG-module 12.

In step 303, the exemplary weighting module 4 may determine a concatenated confidence value ccv₁ of the first class as a function of the first confidence value cv₁₁ of the first class, the second confidence value cv₂₁ of the first class, and a value of a first weighting parameter w₁ of the weighting module.

Similarly, in step 303, the exemplary weighting module 4 may determine a concatenated confidence value ccv₂ of the second class as a function of the first confidence value cv₁₂ of the second class, the second confidence value cv₂₂ of the second class, and a value of a second weighting parameter w₂ of the exemplary weighting module 4.

Similarly, in step 303, the exemplary weighting module 4 may determine a concatenated confidence value ccv₃ of the third class as a function of the first confidence value cv₁₃ of the third class, the second confidence value cv₂₃ of the third class, and a value of a third weighting parameter w₃ of the exemplary weighting module 4.

Similarly, in step 303, the exemplary weighting module 4 may determine a concatenated confidence value ccv₄ of the fourth class as a function of the first confidence value cv₁₄ of the fourth class, the second confidence value cv₂₄ of the fourth class, and a value of a fourth weighting parameter w₄ of the exemplary weighting module 4.

By using different weighting parameters for each class, the weighting of the first and second confidence values cv₁₁, cv₁₂, cv₁₃, cv₁₄, cv₂₁, cv₂₂, cv₂₃, cv₂₄ may be performed as a function of different performances of the ML-module and the KG-module with respect to the different classes. The first and second confidence values cv₁₁, cv₁₂, cv₁₃, cv₁₄, cv₂₁, cv₂₂, cv₂₃, cv₂₄ and the concatenated confidence values ccv₁, ccv₂, ccv₃, ccv₄ may each be a measure of how probable it is to correctly associate the respective class, i.e., the respective point of treatment, to the input dataset 10, i.e., the patient, considering the first use case. The exemplary weighting module 4 may calculate the concatenated confidence values ccv₁, ccv₂, ccv₃, ccv₄ such that the sum of these values is equal to 1. The concatenated confidence values ccv₁, ccv₂, ccv₃, ccv₄ may be exported by the weighting module in the form of an output dataset 13 from the AI-module 1 in a first example. The classification may be performed in a further application.

In a second example, the AI-module may comprise a further classification module 14, which is shown in dashed lines in FIG. 2. The further classification module 14 may select one of the four classes to classify the instant corresponding to the input dataset. The selected class may be the one corresponding to the highest concatenated confidence value ccvₘₐₓ of the concatenated confidence values ccv₁, ccv₂, ccv₃, ccv₄.

In a further alternative, the exemplary AI-module 1 may comprise a bias function 15. The bias function 15 may calculate a bias value based on the input dataset 10. The bias function 15 may comprise one or more parameters for determining the bias value dependent on the input dataset. According to this alternative, the exemplary weighting module 4 performs the weighting dependent on the bias value, e.g., in a manner described above. Values of the parameters of the bias function 15 may be calculated based on the prior distribution described above before performing step 301.

In a further alternative, not shown in FIG. 2, the exemplary weighting module 4 may determine the concatenated confidence values ccv₁, ccv₂, ccv₃, ccv₄ based on a decision rule, the decision rule comprising the weighting parameters w₁, w₂, w₃, w₄.

In a further alternative, the exemplary weighting module 4 may determine the concatenated confidence values ccv₁, ccv₂, ccv₃, ccv₄ using a second machine learning module 16. According to this alternative, the second machine learning module 16 may comprise a neuronal net 17 with a hidden layer and weights. Preferably, the weights of the neuronal net 17 comprise the weighting parameters w₁, w₂, w₃, w₄.

In a further alternative, the exemplary AI-module 1 may comprise a first scoring module 18 and a second scoring module 19. The first scoring module 18 may determine a first scoring value S₁, the first scoring value S₁ representing a value of an uncertainty of the first confidence values cv₁₁, cv₁₂, cv₁₃, cv₁₄. The first scoring value S₁ may be calculated by the first scoring module 18 according to S₁=−Σᵢcv₁ᵢ log cv₁ᵢ.

The second scoring module 19 may determine a second scoring value S₂, the second scoring value S₂ representing a value of an uncertainty of the second confidence values cv₂₁, cv₂₂, cv₂₃, cv₂₄. The second scoring value S₂ may be calculated by the second scoring module 19 according to S₂=−Σᵢcv₂ᵢ log cv₂ᵢ. According to this further alternative, the exemplary weighting module 4 may determine the concatenated confidence values ccv₁, ccv₂, ccv₃, ccv₄ as a function of the first scoring value S₁ and the second scoring value S₂.

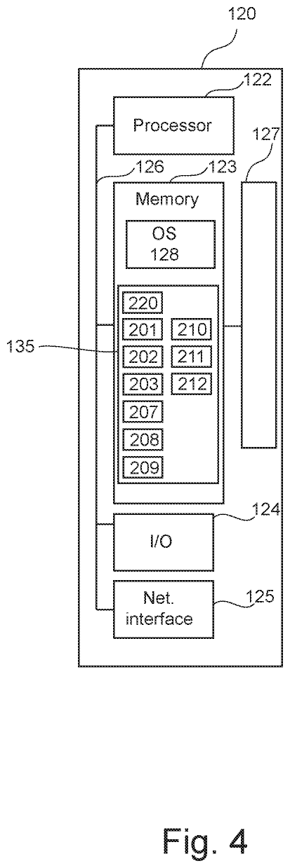

FIG. 4 shows a second computer system 120 for training the exemplary AI-module 1. The second computer system 120 may be suited for performing the training methods as disclosed herein.

Second computer system 120 may include a second processor 122, a second memory 123, a second I/O circuitry 124, and a second network interface 125 coupled together by a second bus 126.

The second processor 122 may represent one or more processors (e.g. microprocessors). The second memory 123 may include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM). Note that the second memory 123 may have a distributed architecture, where various components are situated remote from one another, but may be accessed by the second processor 122.

The second memory 123 in combination with a second persistent storage device 127 may be used for local data and instruction storage. The second storage device 127 includes one or more persistent storage devices and media controlled by the second I/O circuitry 124. The second storage device 127 may include magnetic, optical, magneto optical, or solid-state apparatus for digital data storage, for example, having fixed or removable media. Sample devices include hard disk drives, optical disk drives, and floppy disks drives. Sample media include hard disk platters, CD-ROMs, DVD-ROMs, BD-ROMs, floppy disks, and the like.

The second memory 123 may include one or more separate programs, each of which comprises an ordered listing of executable instructions for implementing logical functions, notably functions involved in examples. The software in the second memory 123 may also typically include a second suitable operating system (OS) 128. The second OS 128 essentially controls the execution of other computer programs for implementing at least part of methods as described herein.

The second computer system 120 may be configured for functions such as executing the above mentioned first, second, and third functions on the second computer system 120.

Furthermore, the second computer system 120 may be configured for functions such as: importing training datasets, the training datasets each comprising an input dataset and an output dataset, wherein each output dataset of the training datasets comprises a confidence value of a first class, referred to as seventh function; determining first training confidence values of the first class according to the training datasets as a function of the input dataset of the respective training dataset using the machine learning module, referred to as eighth function; determining second training confidence values according to the training datasets as a function of the input dataset of the respective training dataset using the knowledge graph module, referred to as ninth function; determining corresponding concatenated training confidence values of the first class according to the respective training datasets each as a function of the respective first training confidence value, the respective second training confidence value, and a value of a weighting parameter of the weighting module, the value of the weighting parameter weighting the respective first training confidence value and the respective second training confidence value for determining the corresponding concatenated training confidence value of the first class, referred to as tenth function; performing a comparison of each concatenated training confidence value of the first class with the confidence value of the first class of the output dataset of the respective training dataset, referred to as eleventh function; and changing a value of the parameter of the AI-module based on the comparisons, referred to as twelfth function.

The second computer system 120 may perform the first, second and third functions and the seventh, eighth, ninth, tenth, and twelfth function by executing the first program 201, the second program 202, the third program 203 and a seventh, eighth, ninth, tenth, and twelfth program 207, 208, 209, 210, 211, 212, respectively. A training module 221 of the exemplary AI-module 1 may be performed by executing a program 421 on the second processor 122. The training the exemplary AI-module 1 may be run by executing a second main program 220 on the second processor 122. The second main program 220 may initiate an execution of the first program 201, the second program 202, and the third program 203 and a seventh, eighth, ninth, tenth, and twelfth program 207, 208, 209, 210, 211, 212 respectively on the second processor 122.

The term “program” as used herein refers to a set of instructions which contains commands to provoke actions performed at least by one of the processors 102, 122 when at least one of the processors 102, 122 may read the commands. The set of instructions may be in the form of a computer-readable program, routine, subroutine or part of a library, which may be executed by at least one of the processors 102, 122 and/or may be called by a further program being executed by at least one of the processors 102, 122. Preferably the programs 200, 220, 201, 202, 203, 204, 205, 206, 207, 208, 209, 210, 211, 212, 421 may be executable programs which are compiled according to a type of hardware platform of the computer systems 100, 120 respectively. The first memory 103 may comprise a space for storing the programs 200, 201, 202, 203, 204, 205, 206; the space hereinafter referred to as first function memory 115. The second memory 123 may comprise a space for storing the programs 220, 201, 202, 203, 207, 208, 209, 210, 211, 212, 421; the space hereinafter referred to as second function memory 135.

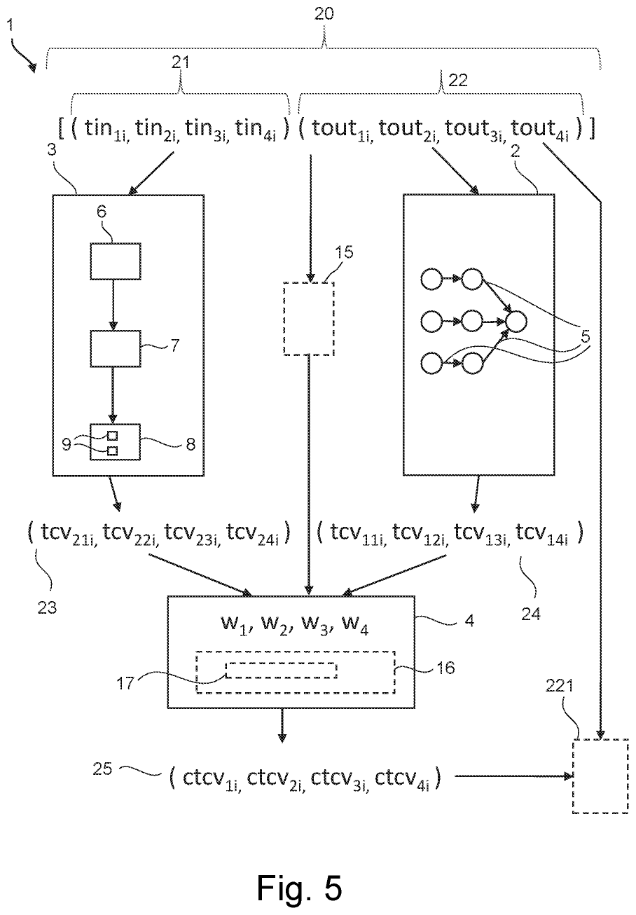

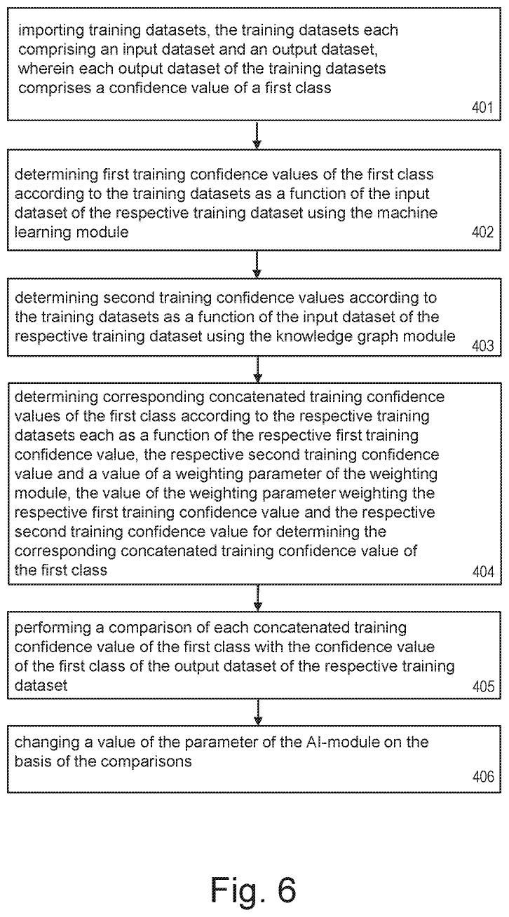

FIG. 5 depicts a block diagram for illustrating a training of the exemplary AI-module 1. FIG. 6 shows a flowchart of a computer implemented method for training the exemplary AI-module 1.

In step 401, training datasets may be imported from the second storage device 127, the training datasets each comprising an input dataset and an output dataset, wherein each output dataset of the training datasets may comprise the same data structure as the output dataset 13 and each input dataset of the training datasets may comprise the same data structure as the input dataset 10. FIG. 6 shows exemplarily an i-th training dataset 20 of the training datasets, comprising an input dataset 21 and an output dataset 22. The input dataset 21 may comprise training input values tin₁ᵢ, tin₂ᵢ, tin₃ᵢ, tin₄ᵢ corresponding to values indicating symptoms of an i-th patient. The output dataset 21 may comprise training output values tout₁ᵢ, tout₂ᵢ, tout₃ᵢ, tout₄ᵢ corresponding to values indicating a confidence value for the first class, the second class, the third class, and the fourth class respectively. Step 401 may be performed by executing program 207 on the second processor 122.

In step 402, the exemplary ML-module 2 may calculate first training confidence values tcv₁₁ᵢ, tcv₁₂ᵢ, tcv₁₃ᵢ, tcv₁₄ᵢ of the respective classes according to the training datasets as a function of the input dataset 21 of the respective training dataset 20. Step 402 may be performed by executing program 208 and program 201 on the second processor 122. The values tcv₁₁ᵢ, tcv₁₂ᵢ, tcv₁₃ᵢ, tcv₁₄ᵢ may be exported by the exemplary ML-module 2 in the form of an output dataset of the exemplary ML-module 24.

In step 403, the exemplary KG-module 3 may calculate second training confidence values tcv₂₁ᵢ, tcv₂₂ᵢ, tcv₂₃ᵢ, tcv₂₄ᵢ of the respective classes according to the training datasets as a function of the input dataset 21 of the respective training dataset 20. Step 403 may be performed by executing program 209 and program 202 on the second processor 122. The values tcv₂₁ᵢ, tcv₂₂ᵢ, tcv₂₃ᵢ, tcv₂₄ᵢ may be exported by the exemplary KG-module 3 in the form of a training output dataset of the exemplary KG-module 23.

In step 404, the weighting module 4 may determine corresponding concatenated training confidence values ctcv₁ᵢ, ctcv₂ᵢ, ctcv₃ᵢ, ctcv₄ᵢ of the first, the second, the third, and the fourth class respectively according to the respective i-th training dataset each as a function of the respective first i-th training confidence values tcv₁₁ᵢ, tcv₁₂ᵢ, tcv₁₃ᵢ, tcv₁₄ᵢ, the respective second i-th training confidence values tcv₂₁ᵢ, tcv₂₂ᵢ, tcv₂₃ᵢ, tcv₂₄ᵢ, and the values of the weighting parameters w₁, w₂, w₃, w₄ of the exemplary weighting module 4. The exemplary weighting module 4 performs a weighting of the respective first training confidence values tcv₁₁ᵢ, tcv₁₂ᵢ, tcv₁₃ᵢ, tcv₁₄ᵢ and the respective second training confidence values tcv₂₁ᵢ, tcv₂₂ᵢ, tcv₂₃ᵢ, tcv₂₄ᵢ for determining the corresponding concatenated training confidence value of the first class, the second class, the third class, and the fourth class respectively. The weighting may be performed based on a training bias value calculated by the bias function 15 dependent on the input dataset 21 of the i-th training dataset 20. Step 404 may be performed by executing program 210 and program 203 on the second processor 122.

The weighting module 4 may export the corresponding concatenated training confidence values ctcv₁ᵢ, ctcv₂ᵢ, ctcv₃ᵢ, ctcv₄ᵢ in the form of a training output vector 25.

In step 405, a training module 221 of the exemplary AI-module 1 may perform a comparison of the i-th concatenated training confidence values ctcv₁ᵢ, ctcv₂ᵢ, ctcv₃ᵢ, ctcv₄ᵢ with the i-th confidence values tout₁ᵢ, tout₂ᵢ, tout₃ᵢ, tout₄ᵢ each with respect to the first class, the second class, the third class, and the fourth class respectively. Step 405 may be performed by executing program 211 and program 421 on the second processor 122.

In step 406, the training module 221 may change a value of at least one of the parameters of the exemplary AI-module 1 based on the comparisons. For that, a training error of the exemplary AI-module 1 may be calculated by calculating a norm of the i-th training dataset on the basis on the comparisons. The comparisons may include calculating a corresponding difference value between the i-th concatenated training confidence values ctcv₁ᵢ, ctcv₂ᵢ, ctcv₃ᵢ, ctcv₄ᵢ and the i-th confidence values tout₁ᵢ, tout₂ᵢ, tout₃ᵢ, tout₄ᵢ of the output dataset of the i-th training dataset with respect to each class. The norm of the i-th training dataset may be a Euclidean norm of a vector comprising the difference value for each class. The above-mentioned steps for determining the norm of the i-th training dataset may be repeated for all training datasets. The norm of each training dataset may be summed up to a training error value of the exemplary AI-module 1.

The training module 221 may change the value of at least one of the parameters of the exemplary AI-module 1 each based on a respective value of a derivative of the training error value of the exemplary AI-module 1 according to the corresponding parameters of the exemplary AI-module 1. Which parameters of the exemplary AI-module 1 may be changed may depend on a training method used to train the exemplary AI-module 1. The training method used to train the exemplary AI-module 1 may preferably be the above-mentioned first, second, third, fourth, or fifth training method. The training method used to train the exemplary AI-module 1 may use gradient-based methods like gradient-descent via backpropagation.

The exemplary AI-module 1 may be tested with test datasets. The test datasets and the training datasets may be selected from available datasets. Preferably, all available datasets may have the same structure. The available datasets may comprise values corresponding to relationships between entities that may be comprised in the available datasets. These values may be used to train the exemplary KG-module 3 and may be in the form of the above described matrices and may be managed in form of the above-mentioned supplementary data structure, preferably by executing the program 202 on the first processor 102 or the second processor 122. Considering the first use case, the entities may be the symptoms. The parameters of the exemplary KG-module 3, which may be changed during the training of the exemplary KG-module 3, may comprise entries of the supplementary data structure.

In one example, the available datasets may be divided into non-overlapping first training datasets, second training datasets, and test datasets. The first training datasets may be used to train the exemplary KG-module 3 and the exemplary ML-module 2 each independently. The second training dataset may be used to train the exemplary AI-module 1 according to one of the training methods mentioned above. The test dataset may be used to test a generalization performance of the exemplary AI-module 1. To divide the available datasets into at least three non-overlapping groups of datasets may have the advantage that the exemplary weighting module 4 may be trained independently from the exemplary KG-module 3 and the exemplary ML-module 2 with respect to the available datasets. This may enhance the generalization performance of the exemplary AI-module 1.

Programs described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for determining a concatenated confidence value of a first class using an artificial-intelligence module (AI-module) for performing a classification based on the concatenated confidence value of the first class, wherein the AI-module comprises a knowledge graph module, a machine learning module, and a weighting module, the computer-implemented method comprising:
determining, by one or more processors, a first confidence value of the first class as a first function of an input dataset using the machine learning module;
determining, by the one or more processors, a second confidence value of the first class as a second function of the input dataset using the knowledge graph module; and
determining, by the one or more processors, the concatenated confidence value of the first class as a third function of the first confidence value of the first class, the second confidence value of the first class, and a value of a weighting parameter of the weighting module, wherein the value of the weighting parameter weights the first confidence value of the first class and the second confidence value of the first class for determining the concatenated confidence value of the first class.

2. The method of claim 1, the method further comprising:
determining, by the one or more processors, a third confidence value of a second class as a fourth function of the input dataset using the machine learning module;
determining, by the one or more processors, a fourth confidence value of the second class as a fifth function of the input dataset using the knowledge graph module;
determining, by the one or more processors, a second concatenated confidence value of the second class as a sixth function of the first confidence value of the second class, the second confidence value of the second class, and a second value of the weighting parameter or a third value of a second weighting parameter of the weighting module, wherein the second value of the weighting parameter or the third value of the second weighting parameter weights the third confidence value of the second class and the fourth confidence value of the second class for determining the second concatenated confidence value of the second class; and
performing, by the one or more processors, the classification based on the concatenated confidence value of the first class and the second concatenated confidence value of the second class.

3. The method of claim 1, further comprising:
performing, by the one or more processors, the weighting of the first confidence value of the first class and the second confidence value of the first class as a fourth function of the input dataset, wherein the value of the weighting parameter is dependent on the input dataset.

4. The method of claim 1, wherein the value of the weighting parameter is dependent on the first confidence value of the first class and the second confidence value of the first class.

5. The method of claim 1, further comprising:
determining, by the one or more processors, a bias value as a fourth function of the input dataset; and
performing, by the one or more processors, the weighting of the first confidence value of the first class and the second confidence value of the first class as a fifth function of the bias value using the weighting module.

6. The method of claim 1, further comprising:
determining, by the one or more processors, a third confidence value of the first class as a fourth function of the input dataset using a second knowledge graph module or a second machine learning module; and
determining, by the one or more processors, the concatenated confidence value of the first class as a fifth function of the first confidence value of the first class, the second confidence value of the first class, and the third confidence value of the first class.

7. The method of claim 1, further comprising:
determining, by the one or more processors, the concatenated confidence value of the first class based on a decision rule, wherein the decision rule comprises the weighting parameter.

8. The method of claim 1, further comprising:
determining, by the one or more processors, the concatenated confidence value of the first class using a second machine learning module, wherein the weighting module comprises the second machine learning module, and wherein the second machine learning module comprises the weighting parameter.

9. The method of claim 8, wherein the second machine learning module comprises a neuronal network with a hidden layer.

10. The method of claim 1, further comprising:
determining, by the one or more processors, a first scoring value and a second scoring value, wherein the first scoring value represents an uncertainty value of the first confidence value of the first class and the second scoring value represents a second uncertainty value of the second confidence value of the first class; and
determining, by the one or more processors, the concatenated confidence value of the first class as a fourth function of the first scoring value and the second scoring value.

11. The method of claim 2, further comprising:
calculating, by the one or more processors, an output dataset of the weighting module using the weighting module, wherein the output dataset of the weighting module comprises concatenated confidence values of several classes including the concatenated confidence value of the first class and the second concatenated confidence value of the second class, and wherein a sum of the concatenated confidence values is equal to 1 or 100 such that each concatenated confidence value represents a probability of the respective class; and
performing, by the one or more processors, the classification based on the output dataset.

12. A computer program product for determining a concatenated confidence value of a first class using an artificial-intelligence module (AI-module) for performing a classification based on the concatenated confidence value of the first class, wherein the AI-module comprises a knowledge graph module, a machine learning module, and a weighting module, the computer program product comprising:
one or more computer readable storage media and program instructions stored on the one or more computer readable storage media, the program instructions comprising:
program instructions to determine a first confidence value of the first class as a first function of an input dataset using the machine learning module;
program instructions to determine a second confidence value of the first class as a second function of the input dataset using the knowledge graph module; and
program instructions to determine the concatenated confidence value of the first class as a third function of the first confidence value of the first class, the second confidence value of the first class, and a value of a weighting parameter of the weighting module, wherein the value of the weighting parameter weights the first confidence value of the first class and the second confidence value of the first class for determining the concatenated confidence value of the first class.

13. The computer program product of claim 12, further comprising:
program instructions to determine a third confidence value of a second class as a fourth function of the input dataset using the machine learning module;
program instructions to determine a fourth confidence value of the second class as a fifth function of the input dataset using the knowledge graph module;
program instructions to determine a second concatenated confidence value of the second class as a sixth function of the third confidence value of the second class, the fourth confidence value of the second class, and a second value of the weighting parameter or a third value of a second weighting parameter of the weighting module, wherein the second value of the weighting parameter or the third value of the second weighting parameter weights the third confidence value of the second class and the fourth confidence value of the second class for determining the second concatenated confidence value of the second class; and
program instructions to perform the classification based on the concatenated confidence value of the first class and the second concatenated confidence value of the second class.

14. The computer program product of claim 12, further comprising:
program instructions to perform the weighting of the first confidence value of the first class and the second confidence value of the first class as a fourth function of the input dataset, wherein the value of the weighting parameter is dependent on the input dataset.

15. The computer program product of claim 12, wherein the value of the weighting parameter is dependent on the first confidence value of the first class and the second confidence value of the first class.

16. The computer program product of claim 12, further comprising:
program instructions to determine a bias value as a fourth function of the input dataset; and
program instructions to perform the weighting of the first confidence value of the first class and the second confidence value of the first class as a fifth function of the bias value using the weighting module.

17. A computer system for determining a concatenated confidence value of a first class using an artificial-intelligence module (AI-module) for performing a classification based on the concatenated confidence value of the first class, wherein the AI-module comprises a knowledge graph module, a machine learning module, and a weighting module, the computer system comprising:
one or more computer processors;
one or more computer readable storage media;
program instructions stored on the computer readable storage media for execution by at least one of the one or more processors, the program instructions comprising:
program instructions to determine a first confidence value of the first class as a first function of an input dataset using the machine learning module;
program instructions to determine a second confidence value of the first class as a second function of the input dataset using the knowledge graph module; and
program instructions to determine the concatenated confidence value of the first class as a third function of the first confidence value of the first class, the second confidence value of the first class, and a value of a weighting parameter of the weighting module, wherein the value of the weighting parameter weights the first confidence value of the first class and the second confidence value of the first class for determining the concatenated confidence value of the first class.

18. The computer system of claim 17, further comprising:
program instructions to determine a third confidence value of a second class as a fourth function of the input dataset using the machine learning module;
program instructions to determine a fourth confidence value of the second class as a fifth function of the input dataset using the knowledge graph module;
program instructions to determine a second concatenated confidence value of the second class as a sixth function of the third confidence value of the second class, the fourth confidence value of the second class, and a second value of the weighting parameter or a third value of a second weighting parameter of the weighting module, wherein the second value of the weighting parameter or the third value of the second weighting parameter weights the third confidence value of the second class and the fourth confidence value of the second class for determining the second concatenated confidence value of the second class; and
program instructions to perform the classification based on the concatenated confidence value of the first class and the second concatenated confidence value of the second class.

19. The computer system of claim 17, further comprising:
program instructions to perform the weighting of the first confidence value of the first class and the second confidence value of the first class as a fourth function of the input dataset, wherein the value of the weighting parameter is dependent on the input dataset.

20. The computer system of claim 17, wherein the value of the weighting parameter is dependent on the first confidence value of the first class and the second confidence value of the first class.
